(19) United States
(12) Patent Application Publication
(10) Pub. No.: US 2025/0270861 A1
(43) Pub. Date: Aug. 28, 2025

(54) DOOR HANDLE APPARATUS AND METHOD FOR MANUFACTURING DOOR HANDLE APPARATUS

(71) Applicant: ALPS ALPINE CO., LTD., Tokyo (JP)

(72) Inventors: Yuzuru KAWANA, Miyagi (JP); Wataru SATO, Miyagi (JP); Masaru KOMATSU, Miyagi (JP); Kazuhito OSHITA, Miyagi (JP)

(21) Appl. No.: 19/208,972

(22) Filed: May 15, 2025

Related U.S. Application Data
(63) Continuation of application No. PCT/JP2023/034524, filed on Sep. 22, 2023.

(30) Foreign Application Priority Data
Nov. 29, 2022 (JP) 2022-190682

(51) Int. Cl. E05B 85/16; E05B 17/00

(52) U.S. Cl. CPC E05B 85/16; E05B 17/0004

(57) ABSTRACT

Door-handle apparatus includes substrate, first-electrode provided on first-surface of the substrate or inside the substrate, second-electrode facing a second-surface of the substrate opposite the first-surface, door-handle case having inner and outer cases, the inner case having first-accommodating-recessed part configured to accommodate the substrate, the outer case being provided so as to cover first-opening part of the first-accommodating-recessed part of the inner-case, cover provided on the second-surface of the substrate, and including both second-opening part facing the second-surface and second-accommodating-recessed part that communicates with the second-opening part and is recessed in a direction away from the second-surface, the second-electrode being provided on innermost-end face of the second-accommodating-recessed part or in innermost-end wall of the second-accommodating-recessed part, and sealing member formed by injecting potting-agent into the first-accommodating-recessed part, the sealing member covering and sealing the substrate and the first-electrode within the first-accommodating-recessed part while leaving exterior-surface of the innermost-end wall exposed.

### CROSS-REFERENCE TO RELATED APPLICATIONS

This application is a continuation application of International Application No. PCT/JP2023/034524, filed on Sep. 22, 2023, and designating the U.S., which is based upon and claims priority to Japanese Patent Application No. 2022-190682, filed on Nov. 29, 2022, the entire contents of which are incorporated herein by reference.

### BACKGROUND

### Technical Field

This disclosure relates to a door handle apparatus and a method for manufacturing the door handle apparatus.

### Background Art

There exists a door handle apparatus in which an integrated electrostatic sensor is placed inside a door handle case. This is achieved by retaining a substrate in a state in which the locking electrode, the unlocking electrode, and circuit components are arranged thereon in a mold, and injecting a molten thermoplastic resin at low pressure to form a sealing member that seals the substrate, the locking electrode, the unlocking electrode, and the circuit components (For example, see Unexamined Japanese Patent Application Publication No. 2020-133150).

### SUMMARY

It should be noted that water intrusion occurring between the inner and outer cases may result in unwanted water retention within a gap between a door handle case's inner surface and a sealing member thereof. Such water retention causes a capacitance change equivalent to that triggered by a hand approaching the door handle apparatus, potentially resulting in a false positive detection of contact with the door handle apparatus.

Here, such a problem might be solved by, for example, increasing the thickness of the sealing member and ensuring that there is a sufficient distance between the place where water may accumulate and, for example, the locking electrode or the unlocking electrode. However, increasing the thickness of the sealing member risks increasing the overall size of the door handle apparatus, and risks introducing defects such as sink marks (localized deficiencies in the thermosetting resin), voids, warpage, or the like during the cooling process of the thermosetting resin for the sealing member.

Therefore, it is an objective to provide a door handle apparatus and a method for manufacturing the door handle apparatus that can mitigate or eliminate false positive detections resulting from water intrusion.

A door handle apparatus according to an embodiment of the present disclosure includes:
a substrate;
a first electrode provided on a first surface of the substrate or inside the substrate;
a second electrode facing a second surface of the substrate opposite to the first surface of the substrate;
a door handle-type handle case having an inner case and an outer case, the inner case having a first accommodating recessed part configured to accommodate the substrate, the outer case being provided so as to cover a first opening part of the first accommodating recessed part of the inner case;
a cover provided on the second surface of the substrate, and including both a second opening part facing the second surface and a second accommodating recessed part that communicates with the second opening part and is recessed in a direction away from the second surface, the second electrode being provided on an innermost end face of the second accommodating recessed part or in an innermost end wall of the second accommodating recessed part; and
a sealing member formed by injecting a potting agent into the first accommodating recessed part, the sealing member covering and sealing the substrate and the first electrode within the first accommodating recessed part, while leaving an exterior surface of the innermost end wall of the cover exposed.

### BRIEF DESCRIPTION OF THE DRAWINGS

FIG. 1 is an diagram illustrating an example of a configuration of a door handle apparatus of an embodiment;

FIG. 2 is exploded diagram illustrating an example of the door handle apparatus of the embodiment;

FIG. 3 illustrates a cross-section view taken along line A-A of FIG. 1 (as indicated by the arrows), as viewed from the lower side;

FIG. 4 is a diagram illustrating an enlarged portion of FIG. 3;

FIG. 5 illustrates an example of the door handle apparatus illustrated in FIG. 1, in a state in which in which an outer case is removed and double- sided tape is not affixed to a cover;

FIG. 6 is a diagram illustrating an example of the door handle apparatus illustrated in FIG. 5, in a state in which the sealing member is removed;

FIG. 7 is an diagram illustrating an example of the door handle apparatus illustrated in FIG. 5, in a state in which an inner case is removed;

FIG. 8 is a diagram illustrating an example of the door handle apparatus illustrated in FIG. 7, in a state in which the sealing member is removed;

FIG. 9 is a diagram illustrating an example of the door handle apparatus illustrated in FIG. 8, in a state in which components of the door handle apparatus are disassembled; and

FIG. 10 is a diagram illustrating the components illustrated in FIG. 8, as viewed from a lower side.

### DETAILED DESCRIPTION OF THE INVENTION

Embodiments to which a door handle apparatus and a method for manufacturing the door handle apparatus of the present disclosure are applied are described below.

To facilitate the description, an XYZ coordinate system is defined below. In the following description, a direction parallel to the X axis (X direction)), a direction parallel to the Y axis (Y direction), and a direction parallel to the Z axis (Z direction) are orthogonal to one another. Also, for the sake of convenience, a −Z direction side is referred to as a lower side or downward and a +Z direction side is referred to as an upper side or upward, but they do not necessarily represent an absolute arrangement in the vertical direction. A plan view means a top view illustrating the XY plane as seen in the Z axis direction.

In the following, the length, thickness, thickness, or the like of each component may be exaggerated for the sake of illustrative clarity. In addition, it is assumed that terms such as parallel, vertical, and the like allow for deviation to such to the extent that the effects of the embodiment are not impaired.

### Embodiments

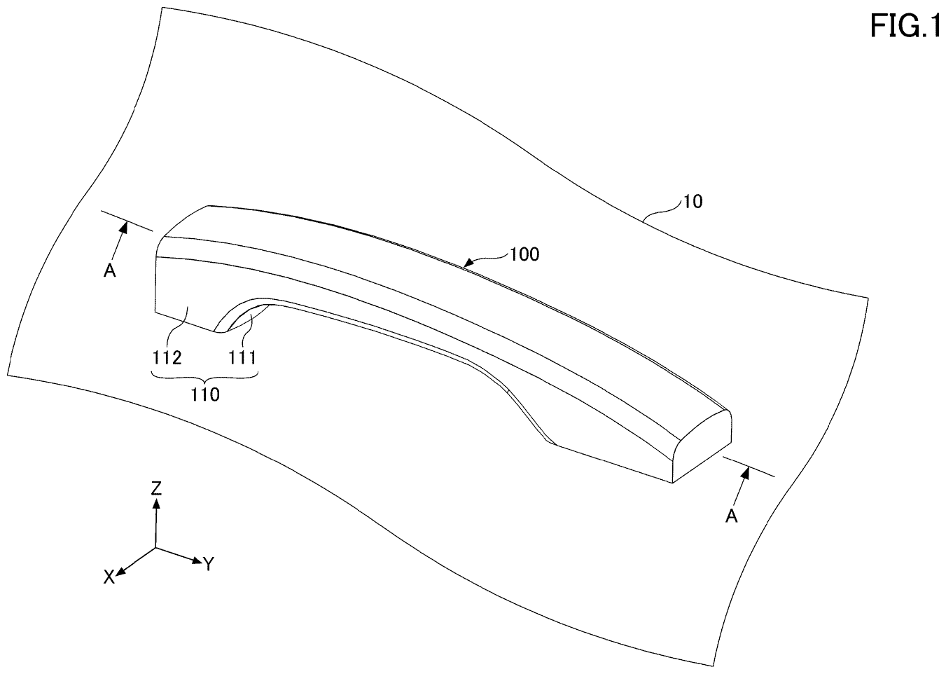

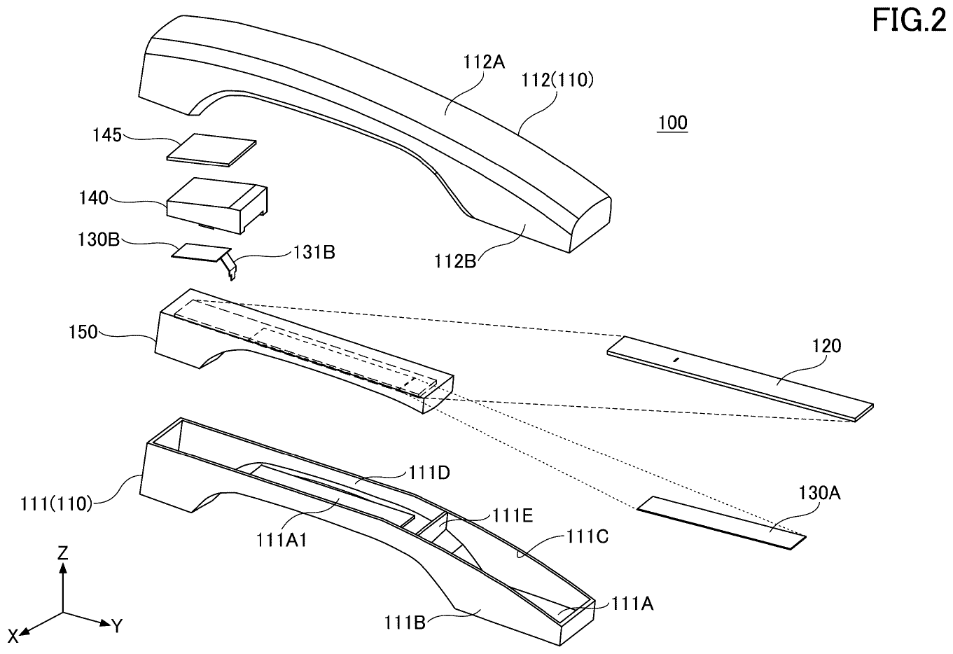

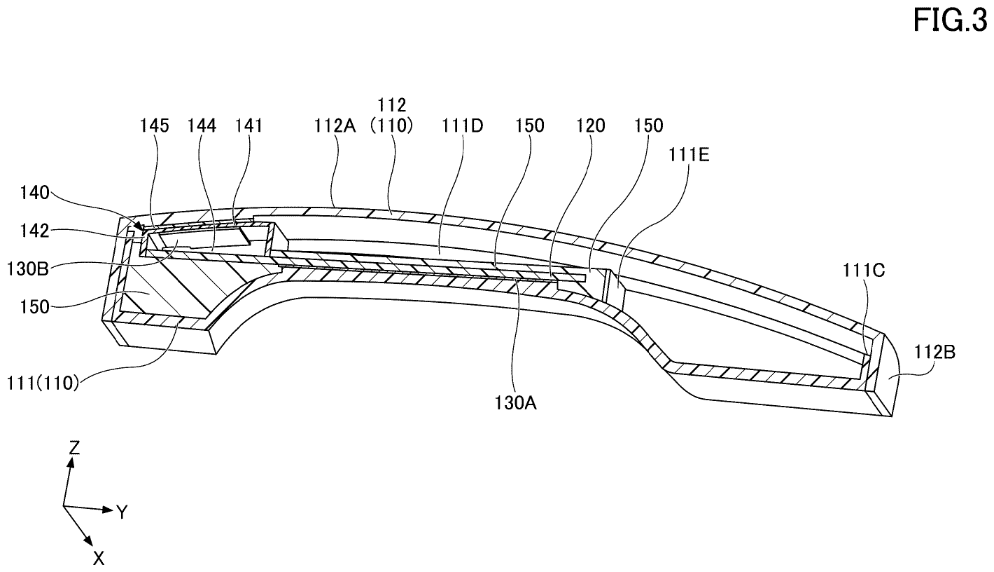

FIG. 1 is an diagram illustrating an example of a configuration of a door handle apparatus 100 of an embodiment. FIG. 2 is an exploded diagram illustrating an example of the door handle apparatus 100 of the embodiment. FIG. 3 illustrates a cross-section view taken along line A-A of FIG. 1 (as indicated by the arrows), as viewed from the lower side. The door handle apparatus 100 is attached to an exterior surface of a door 10 of a vehicle.

The door handle apparatus 100 includes a door handle case 110, a substrate 120, an unlocking electrode 130A, a locking electrode 130B, a cover 140, double-sided tape 145, and a sealing member 150. The door handle case 110 is an example of the handle case and has an inner case 111 and an outer case 112. The unlocking electrode 130A is an example of the first electrode, and the locking electrode 130B is an example of the second electrode. The double-sided tape 145 is an example of the bonding member. Note that double-sided tape or an affixing layer that fixes the locking electrode 130B to the cover 140 is omitted.

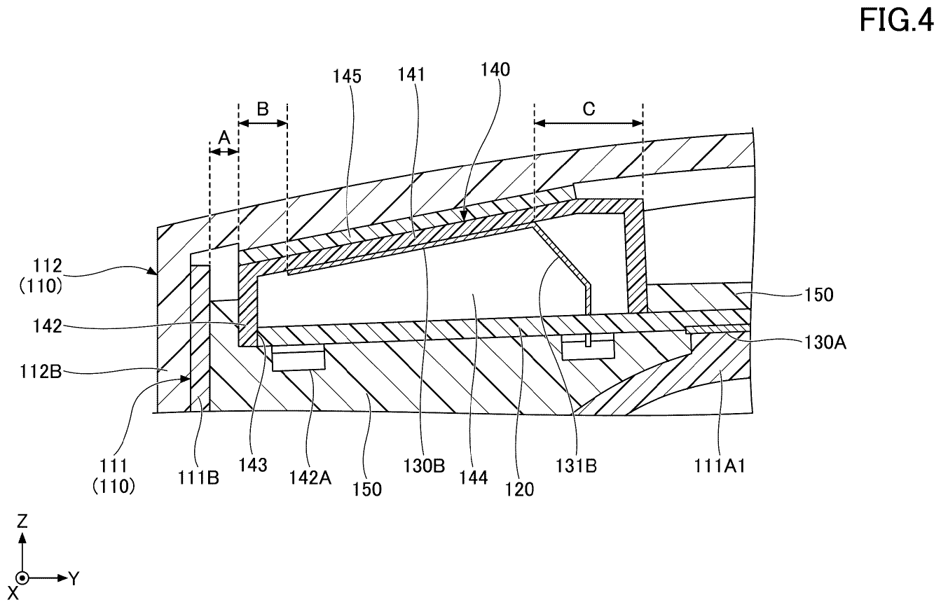

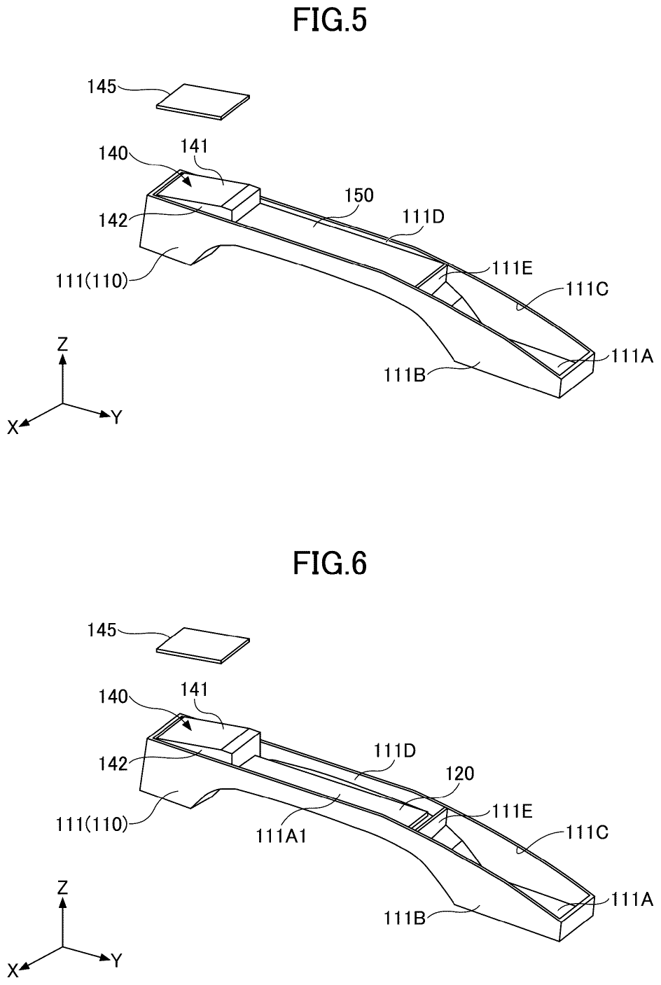

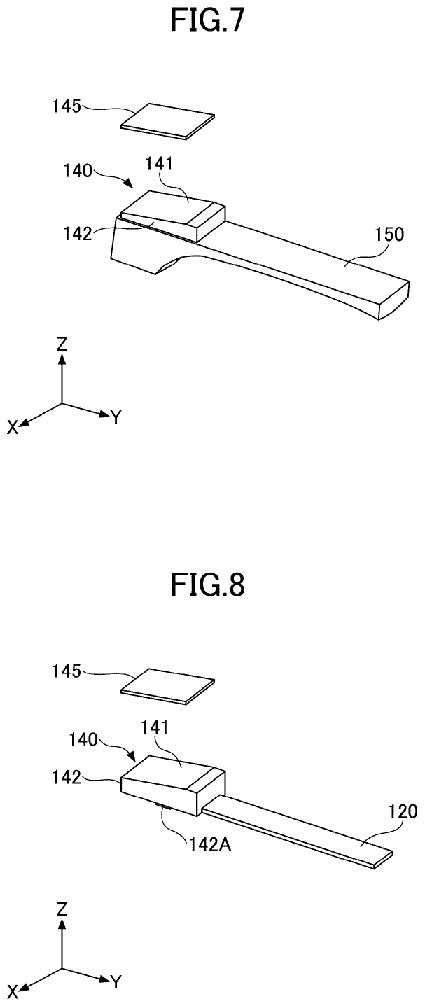

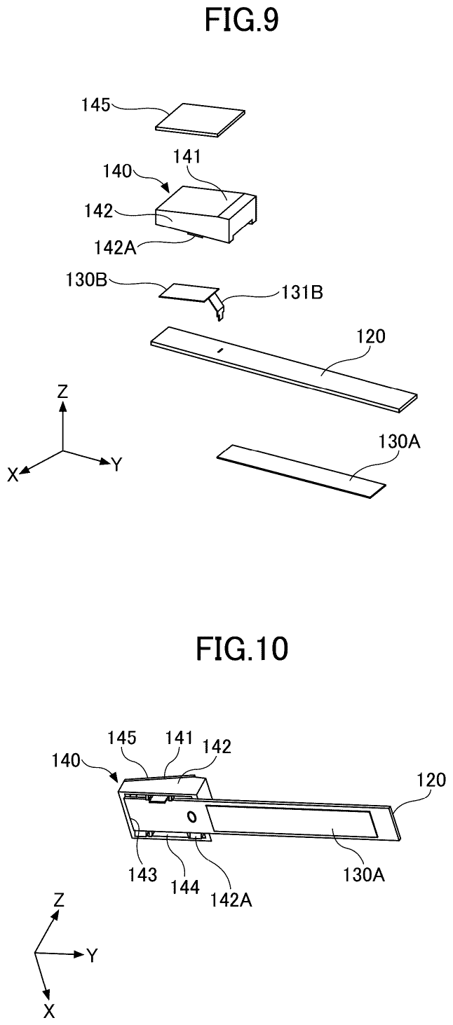

Hereinafter, embodiments of the present disclosure are described below with reference to FIGS. 4 to 10, in addition to FIGS. 1 to 3. FIG. 4 is a diagram illustrating an enlarged portion of FIG. 3. FIG. 5 illustrates an example of the door handle apparatus 100 illustrated in FIG. 1, in a state in which in which the outer case 112 is removed and double-sided tape 145 is not affixed to the cover 140. FIG. 6 is a diagram illustrating an example of the door handle apparatus 100 illustrated in FIG. 5, in a state in which the sealing member 150 is removed. FIG. 7 is a diagram illustrating an example of the door handle apparatus 100 illustrated in FIG. 5, in a state in which the inner case 111 is removed. FIG. 8 is an diagram illustrating an example of the door handle apparatus 100 illustrated in in FIG. 7, in a state in which the sealing member 150 is removed. FIG. 9 is a diagram illustrating an example of the door handle apparatus illustrated in FIG. 8, in a state in which components of the door handle apparatus 100 are disassembled. FIG. 10 is a diagram illustrating the components illustrated in FIG. 8, as viewed from a lower side. In FIG. 10, the double-sided tape 145 is affixed to a top surface of an upper wall 141 of the cover 140.

### Door Handle Case 110

The door handle case 110 has the inner case 111 and the outer case 112. The inner case 111 and the outer case 112 are made of a synthetic resin as an example. The inner case 111 is located on the door 10 side of the outer case 112 with the door handle case 110 attached to the door 10, and is located inward of the outer case 112 at the joint with the outer case 112. The inner case 111 and the outer case 112 form an internal space when combined together.

The inner case 111 has a bottom wall 111A, a side wall 111B, an opening part 111C, an accommodating recessed part 111D, and a partition wall 111E. The accommodating recessed part 111D is an example of the first accommodating recessed part. The inner case 111 is a box-shaped case including the bottom wall 111A located on the bottom side and the side wall 111B enclosing four lateral sides thereof.

The bottom wall 111A has an arch part 111A1 at the center in the Y direction. The arch part 111A1 is a part to be gripped by a user when the door 10 is opened. The bottom wall 111A is arranged on the door 10 at both sides of the arch part 111A1 in the Y direction.

A top end of the side wall 111B is the opening part 111C. The part enclosed by the bottom wall 111A and the side wall 111B is the accommodating recessed part 111D, and the accommodating recessed part 111D communicates with the opening part 111C. The accommodating recessed part 111D accommodates the substrate 120, the unlocking electrode 130A, the locking electrode 130B, the cover 140, the double-sided tape 145, and the sealing member 150. The expression “accommodating” herein permits at least a portion of the substrate 120, the locking electrode 130B, the cover 140, or the double-sided tape 145 to protrude outward beyond the opening part 111C in the YZ plane view.

The partition wall 111E is provided so as to connect the bottom wall 111A, the side wall 111B on the +X direction side and the side wall 111B on the −X direction side, at the +Y direction side of the arch part 111A1. The partition wall 111E is a thin-plate wall parallel to the XZ plane, and the position of the top end of the partition wall 111E is equal to the position of the top end of the side wall 111B, as an example. The partition wall 111E divides the accommodating recessed part 111D into a +Y direction side and a −Y direction side, and is provided to prevent the potting agent configured to form the sealing member 150 from flowing into the +Y direction side. The potting agent is a thermosetting resin such as a urethane resin, an epoxy resin, a silicone resin, or the like; or a dual-component curing resin.

The top ends of the side walls 111B on the +X direction side and −X direction side, as an example, are curved toward the Y direction, and the central portion where the arch part 111A1 is located in the Y direction is the highest portion, and the top ends on the +Y direction side are lower than the top ends on the −Y direction side. The sealing member 150 is not formed on the upper side (+Z direction side) of the partition wall 111E.

The outer case 112 has an outer wall 112A and a side wall 112B, and is a box-shaped case with a recess that substantially mirrors the shape of the accommodating recessed part 111D of the inner case 111 turned upside down. As illustrated in FIG. 3, when the outer case 112 is combined with the inner case 111, the bottom end of the side wall 112B of the outer case 112 covers the outside of the top end of the side wall 111B of the inner case 111. Although the bottom end of the side wall 112B of the outer case 112 overlaps with the top end of the side wall 111B of the inner case 111, the gap therebetween poses a risk of water intrusion into the internal space.

### Substrate 120

The substrate 120 is a wiring substrate having an insulating layer and interconnects (interconnect pattern), with circuit components such as ICs mounted thereon. Terminals or lead wires (not illustrated) configured to electrically connect the circuit components to the outside of the door handle apparatus 100 are also connected. As an example, the substrate 120 is elongated and rectangular in the Y direction in plan view. In the manufacturing step of the door handle apparatus 100, the substrate 120 is sealed with a potting agent while stacked on the unlocking electrode 130A that is placed on the top surface of the arch part 111A1 of the bottom wall 111A of the inner case 111. Therefore, the top surface of the substrate 120 and the four side surfaces are of the substrate are sealed by the sealing member 150. The bottom surface of the substrate 120 is in contact with the top surface of the unlocking electrode 130A. The bottom surface of the substrate 120 has a terminal or the like connected to the unlocking electrode 130A.

### Unlocking Electrode 130A

The unlocking electrode 130A sealed by the sealing member 150 in a state of being placed on the top surface of the arch part 111A1 of the bottom wall 111A of the inner case 111, with the substrate 120 stacked over the upper side of the unlocking electrode 130A. The unlocking electrode 130A is provided on the arch part 111A1 of the door handle case 110 and is configured to detect when the door handle apparatus 100 is gripped by the hand of the user in the case where the locking mechanism of the door 10 is to be unlocked. As an example, the unlocking electrode 130A may be fabricated using a copper plate or the like. The unlocking electrode 130A may be embedded inside the substrate 120. That is, as an example, the unlocking electrode 130A may be achieved by a metal layer included in the inner layer of the wiring substrate as the substrate 120. Further, the unlocking electrode 130A may be formed together with the interconnect by etching a copper foil of the substrate 120 on which the copper foil is formed on the surface.

### Locking Electrode 130B

The locking electrode 130B is fixed to the bottom surface of the upper wall 141 in an accommodating recessed part 144 of the cover 140. As an example, the locking electrode 130B is inclined so as to align with the incline of the bottom surface of the upper wall 141 of the cover 140, so that −Y direction side of the locking electrode 130B is lower. As an example, the locking electrode 130B is a rectangular electrode. As an example, the locking electrode 130B is fixed to the bottom surface of the upper wall 141 by double-sided tape. The locking electrode 130B is spaced apart from a side wall 142 of the cover 140 in the X and Y directions. That is, the locking electrode 130B is provided at a predetermined distance away from the side wall 142 of the cover 140.

The locking electrode 130B is provided to detect a user touching an end part on the −Y direction side of the exterior surface of the outer wall 112A of the outer case 112, when a locking mechanism is to be locked with the door 10 in a closed state. Such a position of the locking electrode 130B is merely an example, and the locking electrode 130B may be provided inside any part of the outer wall 112A of the outer case 112. The locking electrode 130B may be embedded inside the upper wall 141 of the cover 140. This configuration can be achieved by insert molding, as an example.

An extended part 131B is connected to the locking electrode 130B. The extended part 131B extends obliquely downward from the end of the +Y direction side of the locking electrode 130B, as an example, and the bottom end of the extended part 131B is connected to the interconnect on the top surface side of the substrate 120. Such a locking electrode 130B can be fabricated by sheet metal processing of a copper plate as an example together with extended part 131B. The extended part 131B is an example of the connecting part and is configured to connect the locking electrode 130B to the interconnect of the substrate 120. Instead of the extended part 131B, a wire harness or the like may be used to connect the locking electrode 130B to the interconnect of the substrate 120.

### Cover 140

The cover 140 has the upper wall 141, side walls 142, an opening part 143, and the accommodating recessed part 144. The accommodating recessed part 144 is an example of the second accommodating recessed part. The cover 140 is a box-shaped cover including the upper wall 141 and the side walls 142, the latter being disposed on the lower side of the four peripheral edges of the upper wall 141.

Although the +Y direction side-end part of the upper wall 141 is parallel to the XY plane, the end parts other than this +Y direction side-end part are inclined such that the −Y direction side is lower, as an example, in accordance with the shape of the outer case 112.

Among the bottom ends of the side walls 142, the bottom end (−Z direction) of the side wall 142 on the −Y direction side is arranged such that the surface facing towards the +Y direction (the surface on the accommodating recessed part 144 side) is in contact with or close to the side surface on the −Y direction side of the substrate 120, as illustrated in FIG. 4. Likewise, the bottom ends of the side walls 142 on the +X direction side and the −X direction side are arranged such that the surfaces on the accommodating recessed part 144 side are in contact with or close to the side surfaces on the +X direction side and −X direction side of the substrate 120, respectively. Among the bottom ends of the side walls 142, the side wall 142 on the +Y direction side straddles the substrate 120 such that the bottom end in the center in the X direction is higher than the bottom ends on the +X direction side, the-X direction side, and the −Y direction side by approximately the thickness of the substrate 120. Thus, the opening part 143 of the cover 140 is closed by the substrate 120. As an example, engaging parts 142A for snap coupling (See FIG. 10) are provided at the bottom ends of the side walls 142 to securely retain the cover 140 to the substrate 120.

The opening part 143 is a part that encloses the bottom ends of the side walls 142 and communicates with the accommodating recessed part 144. The accommodating recessed part 144 is a recess enclosed by the upper wall 141 and the side walls 142 provided on the lower side of the four peripheral edges of the upper wall 141.

In such a cover 140, the bottom surface of the upper wall 141 is an example of an innermost end face that is located at the innermost part of the accommodating recessed part 144. The upper wall 141 is an example of the innermost end wall.

The cover 140 is snap-coupled to the substrate 120 by three engaging parts 142A as an example, with the locking electrode 130B fixed to the bottom surface of the upper wall 141 so that the opening part 143 is closed by the substrate 120. It is also possible to have the bottom ends of all the side walls 142 be in contact with the top surface of the substrate 120 so that the opening part 143 is sealed by the substrate 120.

The height of the cover 140 is configured such that the upper wall 141 protrudes beyond the side wall 111B and the opening part 111C toward the +Z direction side, while attached to the top surface of the substrate 120. More specifically, the height of the cover 140 is configured such that the position of the locking electrode 130B attached to the bottom surface of the upper wall 141 in the Z direction is located on the +Z direction side relative to the top end of the partition wall 111E, while attached to the top surface of the substrate 120. This ensures that the locking electrode 130B is located on the +Z direction side relative to the top surface of the sealing member 150, when the sealing member 150 is in a formed state.

The reason why the locking electrode 130B is positioned on the +Z direction side relative to the top surface of the sealing member 150 is to reduce the amount of sealing member 150 used. That is, if the locking electrode 130B were to be directly buried and sealed in the sealing member 150 without using the cover 140, the sealing member 150 would need to be positioned on the +Z direction side relative to the top surface of the locking electrode 130B, so a large amount of sealing member would be required. In the present embodiment, since the locking electrode 130B is accommodated inside the accommodating recessed part 144 of the cover 140, the sealing of the locking electrode 130B is possible using a small amount of the sealing member 150. Also, when the locking electrode 130B is positioned on the +Z direction side relative to the top surface of the sealing member 150, the top surface of the upper wall 141 is positioned on the +Z direction side relative to the locking electrode 130B, so the top surface of the upper wall 141 is positioned on the +Z direction side relative to the top surface of the sealing member 150. Therefore, the sealing member 150 is not positioned between the locking electrode 130B and a hand of the user. This is to mitigate or eliminate false positive detections in the locking electrode 130B. The sealing member 150, formed by the potting agent, has a relative permittivity greater than 1. If the sealing member 150 were to be positioned between the locking electrode 130B and the hand, the sealing member 150 would significantly influence the capacitance detected by the locking electrode 130B. To avoid such a situation, the locking electrode 130B is positioned on the +Z direction side relative to the top surface of the sealing member 150. Thus, false positive detections in the locking electrode 130B can be mitigated or eliminated.

It is to be noted that in the state where the cover 140 is attached to the top surface of the substrate 120, the locking electrode 130B does not necessarily have to be located on the +Z direction side relative to the top surface of the sealing member 150. In the state where the cover 140 is attached to the top surface of the substrate 120, it is sufficient as long as at least the top surface of the upper wall 141 is located on the +Z direction side relative to the top surface of the sealing member 150 in the Z direction. This is because, as long as the top surface of the upper wall 141 is exposed from the top surface of the sealing member 150, the sealing member 150 is not located on the upper side of the locking electrode 130B, meaning the influence on the capacitance detected by the locking electrode 130B is minimized.

Also, the position of the top surface of the sealing member 150 is equal to the position of the top end of the partition wall 111E or lower than the position of the top end of the partition wall 111E. Therefore, preferably, in the state where the cover 140 is attached to the top surface of the substrate 120, the locking electrode 130B may be located on the +Z direction side relative to the top end of the partition wall 111E, and it is sufficient as long as at least the top surface of the upper wall 141 is located on the +Z direction side relative to the top end of the partition wall 111E in the Z direction.

Also, as illustrated in FIG. 4, the distance between the side wall 142 on the −Y direction side of the cover 140 and the side wall 111B on the inner case 111 is set as A. The distance in the Y direction between the surface on the −Y direction side of the side wall 142 on the −Y direction side and the end part on the −Y direction side on the locking electrode 130B is set as B. The distance B is an example of the predetermined distance. The distance in the Y direction between the surface on the +Y direction side of the side wall 142 on the +Y direction side and the end part on the +Y direction side of the locking electrode 130B is set as C.

The door handle apparatus 100 is configured such that distance B is a certain distance. The expression “certain distance” denotes a sufficient distance that ensures that the capacitance of the locking electrode 130B remains unaffected, even if water accumulates between the side wall 142 on the −Y direction side of the cover 140 and the side wall 111B of the inner case 111. If distance B is too short, when water accumulates between the side wall 142 on the −Y direction side of the cover 140 and the side wall 111B of the inner case 111, such water retention would cause a capacitance change equivalent to that triggered by a hand approaching the door handle apparatus, potentially resulting in a false positive detection of contact with the door handle apparatus. With the door handle apparatus 100, false positive detections can be mitigated or eliminated by ensuring that distance B is sufficiently large. It is to be noted that distance C is also set to a sufficient distance so that false positive detections can be mitigated or eliminated. The same applies in the X direction.

If the sealing member 150 is positions further toward the +Z direction side, false positive detections can be mitigated or eliminate as this reduces amount of water that accumulates between the side wall 142 of the −Y direction side of the cover 140 and the side wall 111B of the inner case 111 is reduced. Furthermore, in the present embodiment, the amount of sealing member 150 is minimized so that even if the amount of water accumulation is rather high, false positive detections can still be prevented.

In the conventional example in which the integrated electrostatic sensor housed in the door handle case without using the cover 140, water accumulates in the gap between the sealing member and the accommodating recessed part 111D of the inner case 111, and to cope with such a case, it is necessary to set the thickness of the sealing member such that false positive detections do not occur. This risks increases the overall size of the door handle apparatus and risks introducing defects such as sink marks, voids, and warpage when the overall size is increased. However, according to the door handle apparatus of the present disclosure, the possibility of such problems occurring can be reduced.

### Double-Sided Tape 145

The double-sided tape 145 is provided to bond the top surface of the upper wall 141 of the cover 140 to the inner surface of the outer wall 112A of the outer case 112, thereby ensuring the cover 140 is securely fixed in close contact with the inner side of the outer case 112. There is no gap between the cover 140 and the outer case 112 in the state of being fixed together by the double-sided tape 145, thereby ensuring that water does not enter. As such double-sided tape 145, a relatively thick one may be used in order to ensure that the cover 140 is in close contact with the inner side of the outer case 112 to prevent water from entering between the cover 140 and the outer case 112.

### Sealing Member 150

The sealing member 150 is formed by injecting a potting agent into a portion of the accommodating recessed part 111D that is on the −Y direction side relative to the partition wall 111E, while the substrate 120 to which the unlocking electrode 130A and the cover 140 to which the locking electrode 130B is fixed are accommodated inside the portion of the accommodating recessed part 111D that is on the −Y direction side of the partition wall 111E, and by heating and curing the sealing member 150. Then, the sealing member 150 is left until the temperature returns to room temperature. In this manner, the door handle apparatus 100 including the sealing member 150 is manufactured.

That is, the method for manufacturing the door handle apparatus 100 includes a step of forming the sealing member 150 by injecting a potting agent into a portion of the accommodating recessed part 111D on the −Y direction side of the partition wall 111E and curing the substrate 120 having the unlocking electrode 130A and the cover 140 to which the locking electrode 130B is fixed in the accommodating recessed part 111D.

The height of the top surface of the sealing member 150 thus formed is less than or equal to the height of the top end of the partition wall 111E. This is because the potting agent shrinks slightly during curing, and because, after injection, the top surface of the potting agent is less than or equal to the height of the top end of the partition wall 111E.

The sealing member 150 is formed in a portion of the accommodating recessed part 111D enclosed by the bottom wall 111A on the −Y direction side relative to the partition wall 111E and the side walls 111B on the +X direction side, the −X direction side, and the −Y direction side, and has a shape as illustrated in FIG. 7.

Further, the bottom end of the cover 140 is in contact with or is close to both the top surface and the side surfaces of the substrate 120, and thus the bottom end of the cover 140 is sealed by the sealing member 150, in a state in which the sealing member 150 is prevented from entering the accommodating recessed part 111D. As illustrated in FIG. 6, the cover 140 is accommodated in the accommodating recessed part 111D up to a certain height from the bottom end. However, regarding the side walls 142 of the cover 140 in relation to the −Z direction where the opening part 143 is located However, when referring to the side wall 142 of the cover 140 in the −Z direction in which the opening part 143 is located, the bottom end center (the center in the X direction) of the side wall in the +Y direction is brought into contact with the top surface of the substrate 120, and the cover 140 is snap-coupled to the substrate 120. Simultaneously, the faces of the Y-direction side wall, the +X direction side wall, and the −X direction side wall on the accommodating recessed part 111D side are placed in contact with the side surfaces of the substrate 120. This configuration ensures that even when the potting agent is injected, the ingress of the potting agent into the interior of the cover 140 is effectively inhibited. That is, in the method for manufacturing the door handle apparatus 100, when the potting agent is injected into the accommodating recessed part 111D, the interior of the cover 140 is not filled with the potting agent, and the outside of the bottom end side of the cover 140 is sealed by the sealing member 150 together with the substrate 120. The sealing member 150, formed by the potting agent, has a relative permittivity greater than 1. If the sealing member 150 were to be positioned close to the bottom surface of the locking electrode 130B, the value of the capacitance due to the parasitic capacitance increases accordingly, and consequently the amount of change in the capacitance detected by the locking electrode 130B as the person approaches becomes relatively small. To avoid such a situation, the potting agent is prevented from flowing into the cover 140.

As a method of preventing the sealing member 150 from entering the accommodating recessed part 111D, although the opening part 143 is closed using the substrate 120, the bottom wall 111A of the inner case 111 may be provided with a shape in contact with the bottom end surface (surface parallel to the XY plane) of the cover 140 in the −Z direction, and the opening part 143 may be closed in cooperation with the substrate 120. In this case, when the potting material is injected into the accommodating recessed part 111D, the exterior surface (top surface) of the upper wall 141 of the cover 140 may be pressed from the +Z direction side to the −Z direction.

In addition, the potting agent may flow into the cover 140, and even in this case, since the bottom surface of the locking electrode 130B and the sealing member 150 can be spaced apart through the space, the capacitance value due to the parasitic capacitance can be minimized.

Therefore, even if water enters the interior of the cover 140 from the joint between the inner case 111 and the outer case 112, water can be prevented or substantially prevented from entering the interior of the cover. Therefore, false positive detections due to water intrusion into the cover 140 can be mitigated or eliminated.

### Effects

The door handle apparatus 100 is a door handle case that includes the substrate 120, the unlocking electrode 130A provided on the first surface of the substrate 120 or inside the substrate 120, the locking electrode 130B facing the second surface of the substrate 120 opposite to the first surface of the substrate 120, the door handle-type handle case 110 having the inner case 111 and the outer case 112, the inner case 111 having the accommodating recessed part 111D configured to accommodate the substrate 120, the outer case 112 being provided so as to cover the opening part 111C of the accommodating recessed part 111D of the inner case 111, the cover 140 provided on the second surface of the substrate 120, and including both the opening part 143 facing the second surface and the accommodating recessed part 144 that communicates with the opening part 143 and is recessed in a direction away from the second surface, the locking electrode 130B being provided on the innermost end face of the accommodating recessed part 144 or in the upper wall 141 of the accommodating recessed part 144, and the sealing member 150 formed by injecting the potting agent into the accommodating recessed part 111D, the sealing member 150 covering and sealing the substrate 120 and the unlocking electrode 130A within the accommodating recessed part 111D, while leaving the exterior surface of the upper wall 141 of the cover 140 exposed.

Therefore, as long as the exterior surface (top surface) of the upper wall 141 is exposed from the sealing member 150, the sealing member 150 is not located on the upper side of the locking electrode 130B, meaning the influence on the capacitance detected by the locking electrode 130B is minimized.

Therefore, it is possible to provide the door handle apparatus 100 capable of mitigating or eliminating false positive detections resulting from water intrusion.

Further, since the locking electrode 130B is attached to the bottom surface (innermost end face of the upper wall 141, a configuration in which the sealing member 150 is not located on the upper side of the locking electrode 130B can be achieved. Thus, it is possible to provide a method for manufacturing the door handle apparatus 100 and the door handle apparatus 100 capable of mitigating or eliminating false positive detections resulting from water intrusion while minimizing the influence on the capacitance detected by the locking electrode 130B.

In addition, the locking electrode 130B is provided at distance B (predetermined distance) from the side wall 142 located between the opening part 143 of the cover 140 and the upper wall 141. Since distance B is a sufficient distance that ensures that the capacitance of the locking electrode 130B remains unaffected even if the water accumulates between the side wall 142 of the cover 140 and the side wall 111B of the inner case 111, it is possible to provide the door handle apparatus 100 and the method for manufacturing the door handle apparatus 100 capable of mitigating or eliminating false positive detections resulting from water intrusion around the cover 140. In addition, it is possible to make the door handle apparatus 100 more compact by ensuring that distance B is sufficiently large.

In addition, it is also conceivable that the sealing member covering the locking electrode 130B, the substrate 120, and the unlocking electrode 130A, which require waterproofing, should be thickened in the X, Y, and Z directions without providing the cover 140, so as to provide a sufficient distance between the place where water may accumulate and, for example, the locking electrode or the unlocking electrode. However, this risks introducing problems such as the increasing of the overall size of the door handle apparatus; and irregularities in the sealing member resulting from the occurrence of sink marks, voids, warpage, or the like. To cope with this, sealing member 150 of the door handle apparatus 100 of the embodiment can be made thin, and thus such problems are unlikely to occur.

Also, the configuration further includes the double-sided tape 145 to bond the top surface (exterior surface) of the upper wall 141 of the cover 140 to the inner surface of the outer case 112, the double-sided tape 145 brings the cover 140 into close contact with the outer case 112, thereby substantially preventing or preventing water from entering between the cover 140 and the outer case 112. Therefore, it is possible to provide the door handle apparatus 100 and the method for manufacturing the door handle apparatus 100 that can more effectively mitigate or eliminate false positive detections resulting from water intrusion.

Further, instead of having the double-sided tape 145 bring the cover 140 into close contact with the outer case 112, it is conceivable to inject the sealing member, but in order to provide the sealing member to such a high position as that between the cover 140 and the outer case 112, a large amount of the potting agent would need to be injected, which would make it difficult to manufacture the door handle apparatus 100 inexpensively. Therefore, by having the door handle apparatus 100 further include the double-sided tape 145, the double-sided tape 145 can bring the cover 140 into close contact with the outer case 112, thereby preventing water from entering and reducing the cost.

Further, since the extended part 131B configured to connect the locking electrode 130B to the interconnect of the substrate 120 is further included, the locking electrode 130B and the substrate 120 can be reliably connected in accordance with the size of the door handle case 110.

In addition, since the opening part 143 side of the cover 140, i.e., a surface of the cover 140 on a side of the opening part 143, is fixed to the substrate 120, the cover 140 and the substrate 120 can be made into a single cohesive structure, thereby simplifying handling. When the side wall 142 is brought into contact with the top surface of the substrate 120 and the opening part 143 is closed by the substrate 120, the potting agent forming the sealing member 150 can prevent or substantially prevent an inflow of the potting agent into the cover 140 from the opening part 143 by a simple configuration. Since the interior of the cover 140 is a space filled with air, the detection accuracy of the locking electrode 130B can be improved.

The method for manufacturing the door handle apparatus 100 including: the substrate 120, the unlocking electrode 130A provided on the first surface of the substrate 120 or inside the substrate 120, the locking electrode 130B facing the second surface of the substrate 120 opposite to the first surface of the substrate 120, the door handle-type handle case 110 having the inner case 111 and the outer case 112, the inner case 111 having the accommodating recessed part 111D configured to accommodate the substrate 120, the outer case 112 being provided so as to cover the opening part 111C of the accommodating recessed part 111D of the inner case 111, and the cover 140 provided on the second surface of the substrate 120, and including both the opening part 143 facing the second surface and the accommodating recessed part 144 that communicates with the opening part 143 and is recessed in a direction away from the second surface, the locking electrode 130B being provided on the innermost end face of the accommodating recessed part 144 or in the upper wall 141 of the accommodating recessed part 144, the method including: forming the sealing member 150 by injecting a potting agent into the accommodating recessed part 111D, the sealing member 150 covering and sealing the substrate 120 and the unlocking electrode 130A within the accommodating recessed part 111D, while leaving the exterior surface of the upper wall 141 of the cover 140 exposed.

Therefore, as long as the exterior surface (top surface) of the upper wall 141 is exposed from the sealing member 150, the sealing member 150 is not located on the upper side of the locking electrode 130B, meaning the influence on the capacitance detected by the locking electrode 130B is minimized.

Therefore, it is possible to provide the method for manufacturing the door handle apparatus 100 capable of mitigating or eliminating false positive detections resulting from water intrusion.

Although the door handle apparatus and the method for manufacturing the door handle apparatus of the exemplary embodiment of the present disclosure according to specific embodiments have been described, the present disclosure is not limited to the specific embodiments, and various modifications and alterations can be made without departing from the scope of the claims.

What is claimed is:

1. A door handle apparatus, comprising:
a substrate;
a first electrode provided on a first surface of the substrate or inside the substrate;
a second electrode facing a second surface of the substrate opposite to the first surface of the substrate;
a door handle-type handle case having an inner case and an outer case, the inner case having a first accommodating recessed part configured to accommodate the substrate, the outer case being provided so as to cover a first opening part of the first accommodating recessed part of the inner case;
a cover provided on the second surface of the substrate, and including both a second opening part facing the second surface and a second accommodating recessed part that communicates with the second opening part and is recessed in a direction away from the second surface, the second electrode being provided on an innermost end face of the second accommodating recessed part or in an innermost end wall of the second accommodating recessed part; and
a sealing member formed by injecting a potting agent into the first accommodating recessed part, the sealing member covering and sealing the substrate and the first electrode within the first accommodating recessed part, while leaving an exterior surface of the innermost end wall of the cover exposed.

2. The door handle apparatus according to claim 1, wherein the second electrode is attached to the innermost end face.

3. The door handle apparatus according to claim 1, wherein the second electrode is provided at a predetermined distance away from a side wall that is between the second opening part of the cover and the innermost end wall of the cover.

4. The door handle apparatus according to claim 1, wherein the exterior surface of the innermost end wall of the cover further includes a bonding member configured to bond the exterior surface of the innermost end wall of the cover to inner surface of the outer case.

5. The door handle apparatus according to claim 1, further comprising a connecting part configured to connect the second electrode to an interconnect of the substrate.

6. The door handle apparatus to according to claim 1, wherein a surface of the cover on a side of the second opening part is fixed to the substrate.

7. A method for manufacturing a door handle apparatus including:
a substrate;
a first electrode provided on a first surface of the substrate or inside the substrate;
a second electrode facing a second surface of the substrate opposite to the first surface of the substrate;
a door handle-type handle case having an inner case and an outer case, the inner case having a first accommodating recessed part configured to accommodate the substrate, the outer case being provided so as to cover a first opening part of the first accommodating recessed part of the inner case; and
a cover provided on the second surface of the substrate, and including both a second opening part facing the second surface and a second accommodating recessed part that communicates with the second opening part and is recessed in a direction away from the second surface, the second electrode being provided on an innermost end face of the second accommodating recessed part or in an innermost end wall of the second accommodating recessed part, the method comprising:
forming a sealing member by injecting a potting agent into the first accommodating recessed part, the sealing member covering and sealing the substrate and the first electrode within the first accommodating recessed part, while leaving an exterior surface of the innermost end wall exposed.
